(19) United States
(12) Patent Application Publication
(10) Pub. No.: US 2009/0257598 A1
(43) Pub. Date: Oct. 15, 2009

(54) Audio processing system of projector

(75) Inventors: Chih-Chin Lan, Hsinchu (TW); Ta-Ching Lu, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/382,084

(22) Filed: Mar. 9, 2009

(30) Foreign Application Priority Data
Apr. 10, 2008 (TW) 097113101

(51) Int. Cl. H04R 5/00

(52) U.S. Cl. 381/17

(57) ABSTRACT

An audio processing system of projector including a microphone input, an audio input, an audio adjusting unit, and a mixer is provided. The microphone input is utilized for accessing a first audio signal. The audio input is utilized for accessing at least a second audio signal from an outside audio generating device. The audio adjusting unit accesses the first audio signal and the second audio signal and adjusts the first audio signal and the second audio signal according to a selected mode to generate a third audio signal and a fourth audio signal respectively. The mixer is utilized for mixing the third audio signal and the fourth audio signal with an adjustable mixing ratio to output a fifth audio signal.

### BACKGROUND OF THE INVENTION

(1) Field of the Invention

This invention relates to an audio processing system, and more particularly relates to an audio processing system of a projector.

(2) Description of the Prior Art

The projector adopts projection technology to enlarge the image on a micro display to the required image size. The image size of a projector is capable to be much larger than that of a typical flat panel display. Thus, the projector is advantageous to satisfy the need of extra large display.

Though the main function of the projector is to display images, there are usually audio signals needed to be played at the same time. Due to this, there is usually an audio processing system integrated in the projector.

FIG. 1 is a schematic view of a typical audio processing system 100 of a projector. As it shows, the audio processing system 100 has an amplifier 120. The audio signals from left and right channels of a disc driver 110 are amplified by the amplifier 120 and then sent to a rear loudspeaker 130 to generate sound.

If an extra audio input (such as microphone audio) is needed to be played besides the audio signals from left and right channels, the typical method as shown in FIG. 1 is to add an extra audio input device 140 in the audio processing system 100. In addition, a mixer 160 is integrated to the rear end of the audio input device 140 and the amplifier 120 to mix the audio signals input by the audio input device 140 and the audio signals from the left and right channels which are amplified by the amplifier 120.

However, the amplifier 120 and the audio input device 140 in the typical audio processing system 100 in FIG. 1 only provide the function of volume adjustment. In addition, different users have different requirements on the sound effect of the audio processing system 100. Thus, the users usually need to reset the audio processing system 100 to fulfill the requirement when using the projector, which makes the usage more troublesome.

### SUMMARY OF THE INVENTION

The present invention discloses an audio processing system of a projector. The audio processing system is capable to execute various adjustments according to the requirement from the users and to simplify the usage of the projector by means of mode setting.

To achieve one of, a part of or all of the above-mentioned advantages, an embodiment of the present invention provides an audio processing system of a projector. The audio processing system of the projector includes a microphone input, an audio input, an audio adjusting unit, and a mixer. The microphone input is utilized for accessing a first audio signal. The audio input is utilized for accessing at least a second audio signal from an outside audio generating device. The audio adjusting unit is utilized for accessing the first audio signal from the microphone input and the second audio signal from the audio input, and adjusting the first audio signal and the second audio signal according to a selected mode to generate a third audio signal and a fourth audio signal respectively. The mixer is utilized for mixing the third audio signal and the fourth audio signal with an adjustable mixing ratio to output a fifth audio signal.

The conventional audio processing system may not execute various adjustments to meet the requirements of different users. The audio processing system in accordance with the embodiment of the present invention allows diversified settings. In addition, the audio processing system further allows the user to save his favorite setting data such that the user does not have to repeat the complicated settings when using the projector. Thus, the usage of the projector may be simplified.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its embodiment illustrated in the drawings, in which

FIG. 1 is a schematic view of a typical audio processing system of a projector;

FIG. 2 is a block diagram showing an embodiment of an audio processing system of a projector according to the present invention;

FIG. 3 is a block diagram showing an embodiment of the audio adjusting unit and the mixer in FIG. 2;

FIG. 4 is a schematic view showing an embodiment of the audio processing system of a projector processing the setting of the karaoke mode according to the present invention;

FIG. 5 is a schematic view showing an embodiment of the audio processing system of a projector processing the setting of the lecture mode according to the present invention;

FIG. 6 is the schematic view showing an embodiment of the audio processing system of a projector processing the setting of the video mode according to the present invention;

FIG. 7 is a schematic view showing an embodiment of the audio processing system of a projector processing the setting of the user-defined mode according to the present invention; and

FIG. 8 is a schematic view showing an embodiment of the data saved in the storage device according to the present invention.

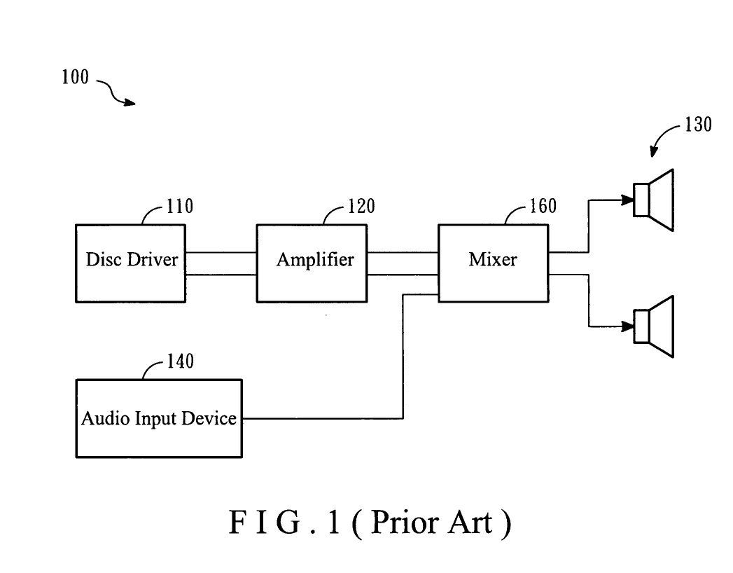

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

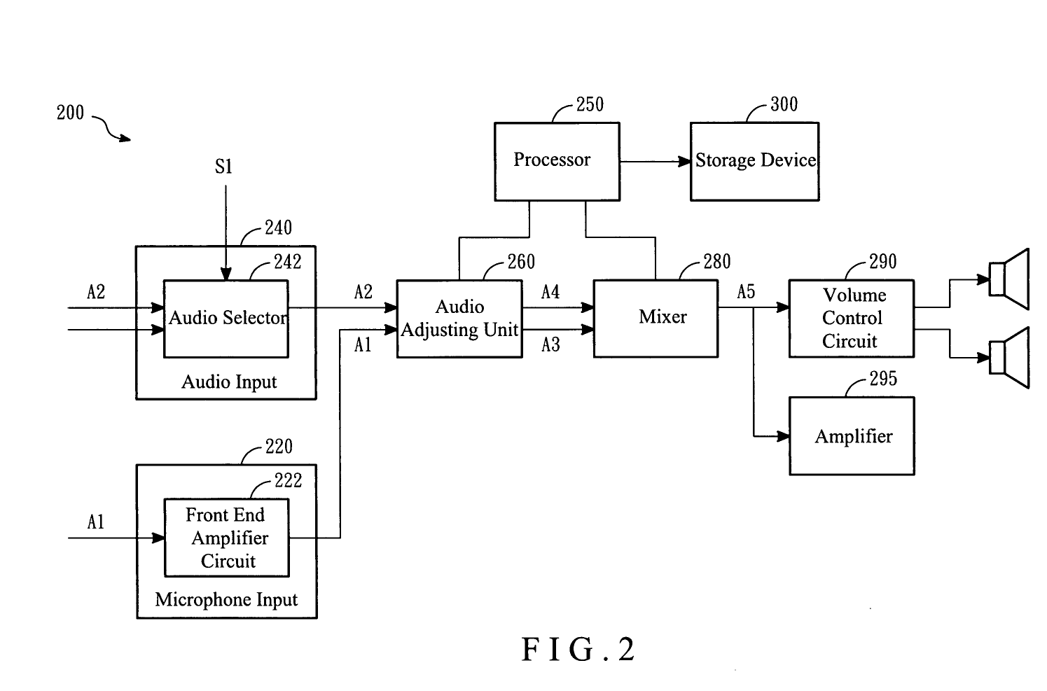

FIG. 2 is a block diagram showing an embodiment of an audio processing system 200 of a projector according to the present invention. As shown, the audio processing system 200 has a microphone input 220, an audio input 240, an audio adjusting unit 260, and a mixer 280. The microphone input 220 is utilized for accessing a first audio signal A1 from the microphone (not shown). For an embodiment, the microphone input 220 has a front end amplifier circuit 222 to amplify the first audio signal A1. The audio input 240 is utilized for accessing at least a second audio signal A2 from an outside audio generating device (not shown). The outside audio generating device may be a disc driver, a multimedia player, or a set-top box. The audio adjusting unit 260 is utilized for accessing the first audio signal A1 from the microphone input 220 and the second audio signal A2 from the audio input 240.

For an embodiment, the audio input 240 has a plurality of input lines to connect a plurality of outside audio generating devices respectively. In case there are a plurality of second audio signals A2, each of the second audio signals A2 is generated by the corresponded outside audio generating device. However, the audio input 240 only selects one of the second audio signals A2 generated by the corresponding outside audio generating device for further processing. In order to select one of the second audio signal A2 generated by the outside audio generating devices, as shown in FIG. 2, the audio input 240 has an audio selector 242. The audio selector 242 is utilized to select one of the second audio signals A2 generated by the outside audio generating devices according to a control signal S1 and sends the selected second audio signal A2 to the audio adjusting unit 260. For example, users may use the audio selector 242 to select the audio signal from a disc driver or a set-top box as the second audio signal A2 to be sent to the audio adjusting unit 260.

The audio adjusting unit 260 is utilized for accessing the first audio signal A1 from the microphone input 220 and the second audio signal A2 from the audio input 240. Moreover, the audio adjusting unit 260 may adjust the first audio signal A1 and the second audio signal A2 according to a selected mode. For example, the selected mode may be selected from a karaoke mode, a lecture mode, a video mode, or a user-defined mode.

The first audio signal A1 and the second audio signal A2 are adjusted by the audio adjusting unit 260 to generate a third audio signal A3 and a fourth audio signal A4 respectively. The third audio signal A3 and the fourth audio signal A4 are output to the mixer 280. The mixer 280 is utilized for mixing the third audio signal A3 and the fourth audio signal A4 with an adjustable mixing ratio to output a fifth audio signal A5. The fifth audio signal A5 may be output to the amplifier for further processing or to the speaker to generate sound. For an embodiment, the audio processing system 200 has a processor 250 which may control the operation of the audio adjusting unit 260 and the mixing ratio of the mixer 280 according to the selected mode.

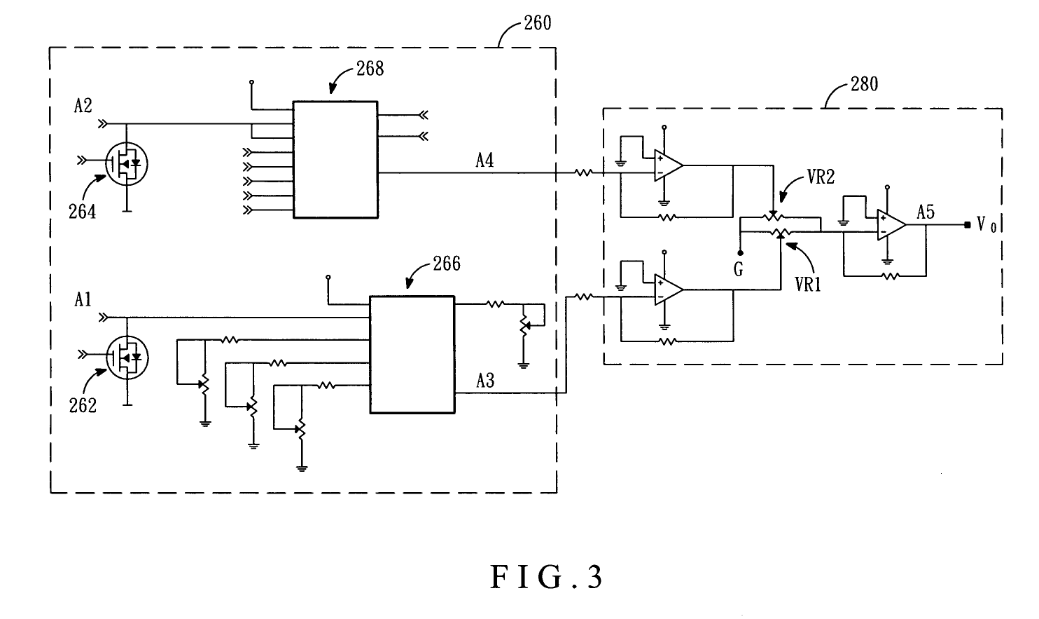

FIG. 3 is the block diagram showing an embodiment of the audio adjusting unit 260 and the mixer 280 in FIG. 2. As shown, the audio adjusting unit 260 has a microphone mute switch 262, an outside audio mute switch 264, a microphone audio processing circuit 266, and an outside audio processing circuit 268. The microphone mute switch 262 is utilized to selectively stop the input of the first audio signal A1 according to the selected mode. The outside audio mute switch 264 is utilized to selectively stop the input of the second audio signal A2 according to the selected mode.

When the microphone mute switch 262 is closed, the first audio signal A1 is sent to the microphone audio processing circuit 266 to generate the third audio signal A3. For an embodiment, the microphone audio processing circuit 266 may adjust echo, tone, microphone acoustics, and stereo effect of the first audio signal A1.

When the outside audio mute switch 264 is closed, the second audio signal A2 is sent to the outside audio processing circuit 268 to generate the fourth audio signal A4. For an embodiment, the outside audio processing circuit 268 may process audio equalization adjustment of the second audio signal A2. For example, the outside audio processing circuit 268 may be loaded with seven modes of different equalization settings including natural music, pop music, classical music, gentle music, jazz, super bass, and normal.

The mixer 280 is utilized for mixing the third audio signal A3 and the fourth audio signal A4 generated by the audio adjusting unit 260 with an adjustable mixing ratio to output a fifth audio signal A5. The mixer 280 has a first variable resistor VR1, a second variable resistor VR2, and an output end Vo. The first variable resistor VR1 and the second variable resistor VR2 are connected in parallel between the output end Vo and a grounding end G. The third audio signal A3 and the fourth audio signal A4 generated by the audio adjusting unit 260 are input to the first variable resistor VR1 and the second variable resistor VR2 respectively. The third audio signal A3 and the fourth audio signal A4 are mixed to generate the fifth audio signal A5. The fifth audio signal A5 is output from the output end Vo. The volume of the third audio signal A3 and the fourth audio signal A4 may be controlled by adjusting resistance of the first variable resistor VR1 and the second variable resistor VR2. The mixing ratio of the third audio signal A3 and the fourth audio signal A4 may be adjusted by changing the ratio of resistance of the first variable resistor VR1 and the second variable resistor VR2. Furthermore, as shown in FIG. 2, the fifth audio signal A5 generated by the mixer 280 may be sent to a volume control circuit 290 or an amplifier 295 to adjust the volume of the output audio signal.

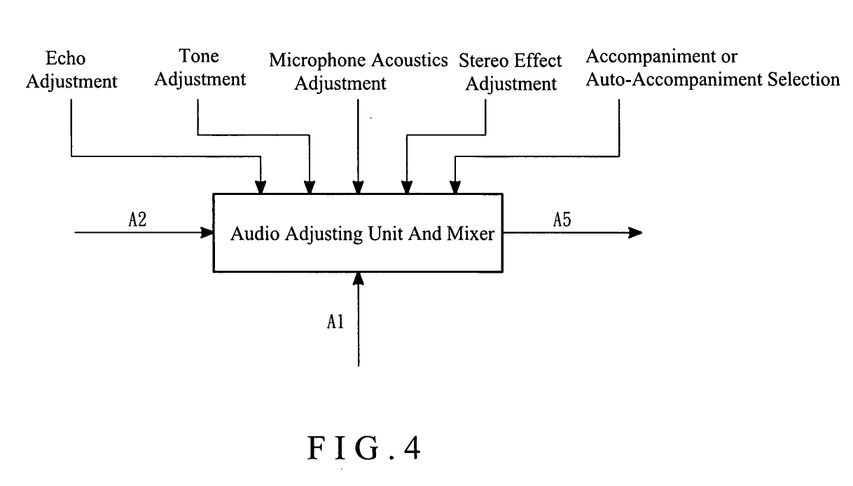

As mentioned above, the audio adjusting unit 260 may be utilized to adjust the first audio signal A1 and the second audio signal A2 according to the selected mode. The selected mode may be a karaoke mode, a lecture mode, a video mode, or a user-defined mode. As shown in FIG. 4, in the karaoke mode, both the first audio signal A1 and the second audio signal A2 are input to the audio adjusting unit 260. The audio adjusting unit 260 may adjust echo, tone, microphone acoustics, and stereo effect of the first audio signal A1 as well as process equalization adjustment of the second audio signal A2. For example, users may select the functions of accompaniment or auto-accompaniment.

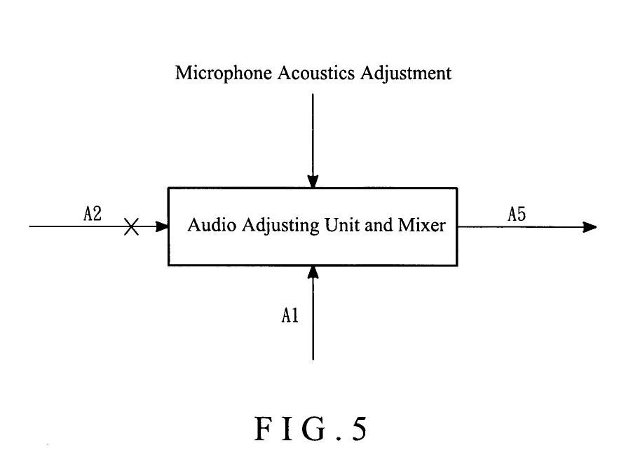

Referring to FIG. 5 and FIG. 3, in the lecture mode, the outside audio mute switch 264 is opened to stop the input of the second audio signal A2. In this mode, the adjustment executed by the audio adjusting unit 260 is limited to adjusting the microphone acoustics of the first audio signal A1.

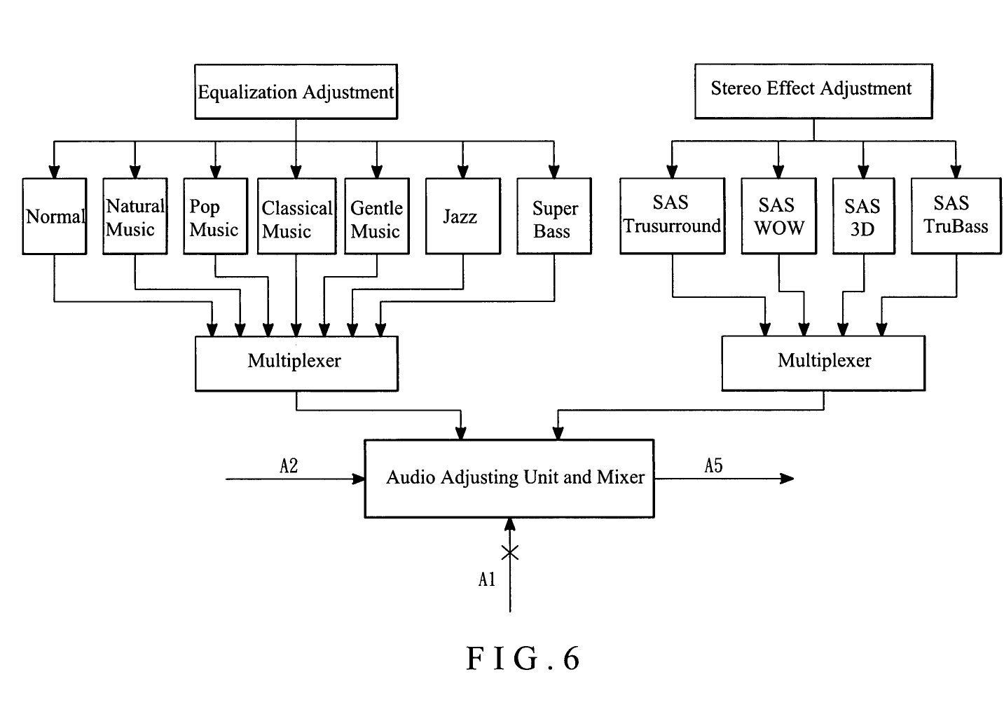

Referring to FIG. 6 and FIG. 3, in the video mode, the microphone mute switch 262 is opened to stop the input of the first audio signal A1. In this mode, the audio adjusting unit 260 may process equalization adjustment of the second audio signal A2. For example, users may choose a sound mode from the seven modes of different equalization settings including natural music, pop music, classical music, gentle music, jazz, super bass, and normal. In addition, the audio adjusting unit 260 may adjust the stereo effect of the second audio signal A2 to simulate surrounding sound effect. For example, users may select different surrounding sound effect simulation such as SRS (sound retrieval system) Trusurround, SRS WOW, SRS 3D or SRS TruBass.

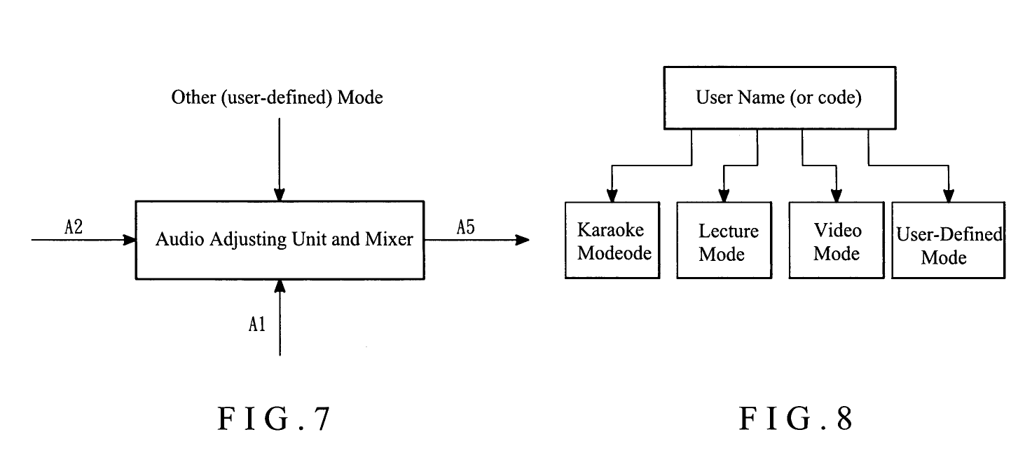

Referring to FIG. 7, in the user-defined mode, users may adjust the setting of the audio signals according to their favorites. For example, users may adjust tone of the microphone and accompaniment volume based on his own tone and volume. In addition, if the user prefers war films, he may adjust the equalization setting of the super bass.

It is noted that the audio processing system 200 in accordance with the embodiment of the present invention provides default settings of the above mentioned karaoke mode, lecture mode, and video mode. However, each default setting may be adjusted by users according to their requirements. In addition, for a preferable embodiment, users may processing the setting through an OSD (On Screen Display) interface or select the mode through the OSD interface.

In order to save the data set by the user, as shown in FIG. 2, the audio processing system 200 has a storage device 300 in accordance with the embodiment of the present invention. The users may set the karaoke mode, the lecture mode, and the video mode and save the set data into the storage unit 300. In addition, the user may define the user-defined mode and save the data thereof into the storage device 300. As shown in FIG. 8, the data saved in the storage device 300 may include a plurality of user names (or code representing the user) and the data of karaoke mode, lecture mode, video mode, and user-defined mode set by each user. Thus, when using the projector, users only have to select the mode saved in advance rather than repeat complicated settings.

The conventional audio processing system 100 may not execute various adjustments to meet the requirements of different users. In contrast, as shown in FIG. 3, the audio processing system 200 in the present invention allows diversified settings. As shown in FIG. 4 to FIG. 7, the audio processing system 200 also provides karaoke mode, lecture mode, video mode, and user-defined mode to satisfy different requirements from the users and simplify audio adjusting procedure. In addition, as FIG. 8 shows, the audio processing system 200 further allows the user to save his favorite setting data such that the user would not have to repeat the complicated settings when using the projector. Thus, the usage of the projector may be simplified.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best model practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An audio processing system of a projector, comprising:
a microphone input, for accessing a first audio signal;
an audio input, for accessing at least a second audio signal from an outside audio generating device;
an audio adjusting unit, for accessing the first audio signal from the microphone input and the second audio signal from the audio input, and adjusting the first audio signal and the second audio signal according to a selected mode to generate a third audio signal and a fourth audio signal respectively; and
a mixer, mixing the third audio signal and the fourth audio signal with an adjustable mixing ratio to output a fifth audio signal.

2. The audio processing system of a projector of claim 1, wherein the audio adjusting unit has a microphone mute switch utilized to selectively stop the input of the first audio signal to the audio adjusting unit according to the selected mode.

3. The audio processing system of the projector of claim 1, wherein the audio adjusting unit has an outside audio mute switch utilized to selectively stop the input of the second audio signal to the audio adjusting unit according to the selected mode.

4. The audio processing system of a projector of claim 1, wherein the selected mode is selected from the group consisting of a karaoke mode, a lecture mode, a video mode and a user-defined mode.

5. The audio processing system of a projector of claim 1, wherein the microphone input has an amplifier circuit to amplify the first audio signal.

6. The audio processing system of a projector of claim 1, wherein the audio input has an audio signal selector, and when a plurality of the second audio signals are generated, the audio signal selector is used to select one of the second audio signals and send the selected second audio signal to the audio adjusting unit.

7. The audio processing system of a projector of claim 1 further comprising a storage device to save data of the selected mode.

8. The audio processing system of a projector of claim 7, wherein the storage device is capable of saving data of the selected mode set by different users.

9. The audio processing system of a projector of claim 1 further comprising a processor to control the audio adjusting unit according to the selected mode.

10. The audio processing system of a projector of claim 1, wherein the mixer has a first variable resistor, a second variable resistor, and an output end, the first variable resistor and the second variable resistor are connected in parallel between the output end and a grounding end, the third audio signal and the fourth audio signal are input to the mixer by the first variable resistor and the second variable resistor respectively, and the fifth audio signal is output by the output end.

11. The audio processing system of a projector of claim 1, wherein users set the selected mode through an on screen display interface.
